(19) United States
(12) Patent Application Publication
(10) Pub. No.: US 2005/0044449 A1
(43) Pub. Date: Feb. 24, 2005

(54) Power button and device wake event processing methods in the absence of AC power

(76) Inventor: Robert A. Dunstan, Forest Grove, OR (US)

Correspondence Address: SCHWABE, WILLIAMSON & WYATT, P.C.;PACWEST CENTER, SUITES 1600-1900, 1211 SW FIFTH AVENUE, PORTLAND, OR, 97204, US

(21) Appl. No.: 10/644,628

(22) Filed: Aug. 19, 2003

(51) Int. Cl. G06F 11/00

(52) U.S. Cl. 714/25

(57) ABSTRACT

A system is provided with circuitry to signal the system being in an AC failure state, and to negate at least one of a power button event signal and a device wake event signal, if the system is in the AC failure state.

### BACKGROUND

Advances in integrated circuits and microprocessor technologies have made possible the availability of computing devices, such as personal computers, with computing power that was once reserved for “main frames”. As a result, increasingly computing devices, such as personal computers, are being used for a wide array of computations, and often, “important” computations.

However, computing devices, such as personal computers, are still being provided without integral backup power support. Further, unlike their server brethrens, typically, supplemental external backup power supports are seldom employed. Thus, whenever the power supply fails, these computing devices go into an un-powered state, and the system states are lost.

For those computing devices endowed with power management implemented in accordance with the Advanced Configuration and Power Interface (ACPI) (jointly developed by Hewlett Packard, Intel, et al), the computing devices are said to be in the “un-powered” G3 state.

Moreover, when power is restored, and a user presses the power button of the computing device, the user typically gets a number of messages from the operating system (OS) of the computing device. Unfortunately, many of these messages are understood by sophisticated users only. Examples of these messages include asking the user whether the user desires to boot the computing device into a safe mode, have the disk drive scanned, and so forth.

If acceptance of computing devices, such as personal computers, is to continue to expand, and the computing devices are to be used by more and more users for an increasing variety of applications, such as “entertainment” applications, it is necessary for their usability, availability, and/or reliability to continue to improve. Further, it is necessary for the usability, availability, and/or reliability to be improved cost effectively.

### BRIEF DESCRIPTION OF THE DRAWINGS

Embodiments of the present invention will be described by way of the accompanying drawings in which like references denote similar elements, and in which:

FIG. 1 illustrates an overview of a system incorporated with the teachings of one embodiment of the present invention, including a controller equipped to suppress or ignore power button and device wake events during AC absence;

FIG. 2a illustrates the operational states of the system of FIG. 1, in accordance with one embodiment;

FIG. 2b illustrates one embodiment of the power supply of FIG. 1 in further details including a monitor for monitoring presence/absence of AC and a DC power source;

FIG. 3 illustrates one embodiment of the relevant operation flow of the system to suspend to system to memory in responding to an AC failure condition, while operating in an active state;

FIG. 4 illustrates one embodiment of the relevant operation flow of the system to resume the system into an active state, in responding to an AC re-presence condition, while operating in a suspended state; and

FIG. 5 illustrates one embodiment of the relevant portion of controller/bus bridge of FIG. 1 for suppressing power button and device wake events.

### DETAILED DESCRIPTION OF EMBODIMENTS OF THE INVENTION

Embodiments of the present invention include but are not limited to method for processing power button and device wake events, chipsets equipped to selectively suppress these events while AC failed, power supply equipped to signal AC failure, components, circuit boards, and systems equipped with the chipset and/or power supply.

In the following description, various aspects of embodiments of the present invention will be described. However, it will be apparent to those skilled in the art that other embodiments may be practiced with only some or all of the described aspects. For purposes of explanation, specific numbers, materials and configurations are set forth in order to provide a thorough understanding of the embodiments. However, it will be apparent to one skilled in the art that other embodiments may be practiced without the specific details. In other instances, well-known features are omitted or simplified in order not to obscure the description.

Various operations will be described as multiple discrete operations in turn, in a manner that is most helpful in understanding the embodiments, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

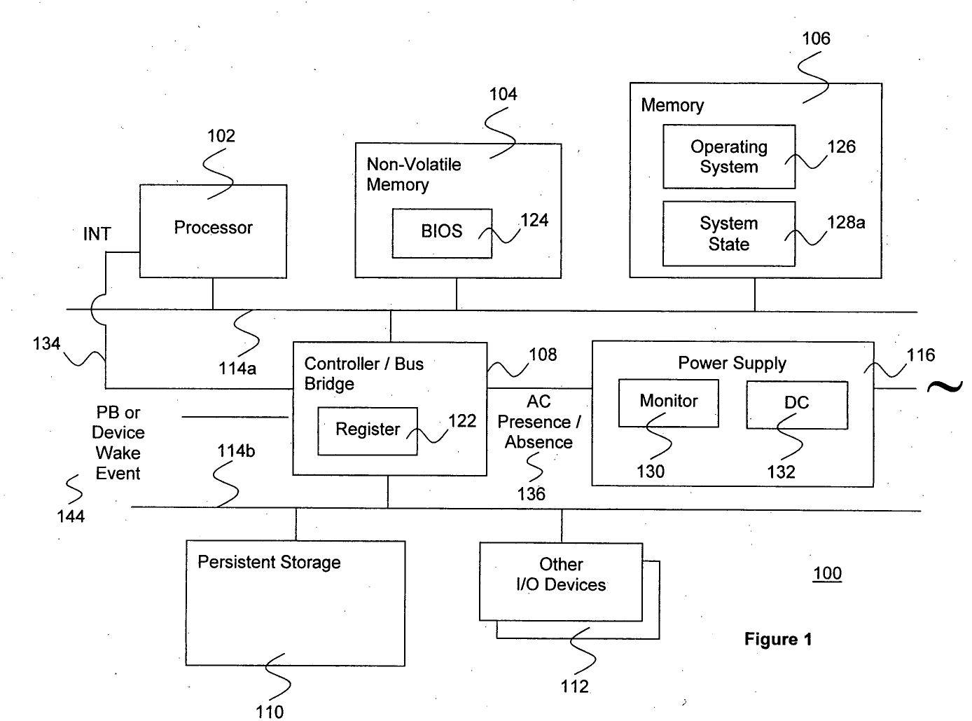

Referring now to FIG. 1 wherein an overview of a system incorporated with the teachings of one embodiment of the present invention is illustrated. For the embodiment, system 100 includes processor 102, non-volatile memory 104, memory 106, controller/bus bridge 108, persistent storage 110, other I/O devices 112, buses 114a-114b, and power supply 116, coupled to each other as shown. Controller/bus bridge 108 will also be referred to as memory and I/O controller/bus bridge, or MCH/ICH/BB.

Non-volatile memory 104 includes in particular basic input/output system (BIOS) 124. Memory 106 includes a working copy of operating system (OS) 126 and system state data 128a. The term “system state” as used herein includes OS and application states and data.

MCH/ICH/BB 108 is equipped to interrupt processor 102, when system 100 is in an active state and an AC failed or absent condition arises. More specifically, for the embodiment, the interrupt is issued by the ICH portion of MCH/ICH/BB 108. MCH/ICH/BB 108 is further equipped to facilitate OS 126 to cause system 100 to go into the “suspended to memory” state. Further, MCH/ICH/BB 108 is equipped to shut off delivery of “normal” power (leaving only standby power) to cause system 100 to go into a “suspended to memory” state. MCH/ICH/BB 108 is also equipped to process device wake events, including a notification of AC re-presence while system 100 is in a suspended to memory state. In particular, MCH/ICH/BB 108 is equipped to allow resumption of delivery of “normal” power, initiate waking of system 100, and facilitate BIOS to initiate a resume process. Similarly, for the embodiment, processing of device wake events is performed at the ICH portion MCH/ICH/BB 108. [AC=Alternating Current.]

Power supply 116 includes integral backup DC power source 132, to source power for system 100 while system 100 is in an AC failed or absent condition, and a monitor 130 equipped to signal 136 presence or absence of AC power at power supply 116. An example of integral backup DC power source 132 is a battery. For the purpose of present application, the terms “AC failed” or “AC absence” should be considered synonymous, unless the context clearly indicates to the contrary. Hereinafter, integral backup DC power source 132 may also be simply referred to as either backup power source or DC power source. Further, in alternate embodiments backup power source may be a non-DC power source. [DC=Direct Current.]

For the purpose of this application, signal 136 is nominally referred to as a “power” signal in that it conveys information about the state of power supply 116. However, signal 136 (or its derivative) is also referred to as a “state” signal, in that it conveys the power state of system 100. A derivative “state” signal may be generated employing a simple circuit (not shown) comprising e.g. a latch, or a complex application dependent circuit (not shown) taking into-other considerations. Regardless, the circuit may be disposed at MCH/ICH/BB 108b or other elements of system 100.

Additionally, MCH/ICH/BB 108, includes in particular terminals (e.g. pins (not shown)) for receiving one or more signals 144 denoting one or more power button related and/or device wake events. Further, MCH/ICH/BB 108 includes logic (not shown) for suppressing or ignoring these signals, when system 100 is powered by DC power source 132 in a suspended to memory state, during absence of AC. More specifically, for the embodiment, the logic is implemented in the ICH portion of MCH/ICH/BB 108.

Examples of device wake events 144 include but are not limited to a modem element receiving a call while system 100 is in the suspended to memory state, a networking element receiving a packet while system 100 is in the suspended to memory state, and so forth.

By suppressing or ignoring power button and wake device events 144 when system 100 is powered by DC power source 132 in a suspended to memory state, during absence of AC, system 100 is prevented from starting up or waking up and becoming a large load for DC power source 132. Resultantly, the capacity of integral back up DC power source 132 may be smaller, and less costly. In turn, system 100 may be provided with integral backup power, more specifically, integral DC backup power 132, in a more cost effective manner.

Still referring to FIG. 1, except for teachings of embodiments of the present invention incorporated, processor 102, non-volatile memory 104, memory 106, MCH/ICH/BB 108, persistent storage 110, I/O devices 112, and buses 114a-114b all represent corresponding broad ranges of these elements. In particular, an example of an I/O device is a networking interface. Likewise, BIOS 124 and OS 126 also represent corresponding broad ranges of the elements. Further, MCH/ICH/BB 108 and/or other components may be packaged in the form of a chipset.

Various embodiments of these teachings incorporated in MCH/ICH/BB 108, power supply 116, the operational states and various operational flows of system 100 will be described in turn below.

In various embodiments, system 100 may be a desktop computer, a set-top box, an entertainment control console, a video recorder, or a video player.

Further, alternate embodiments may be practiced without some of the enumerated elements or with other elements. In particular, alternate embodiments may be practiced without DC power source 132 being an integral part of system 100. That is, for these embodiments, DC power is provided from a source external to system 100.

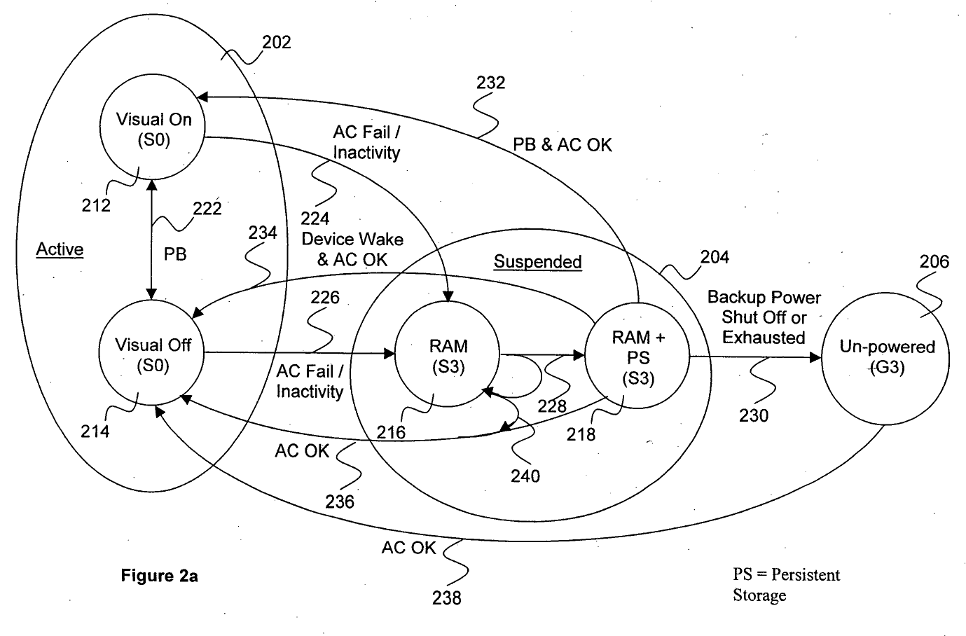

FIG. 2a illustrates one embodiment of the operational states of system 100. For ease of understanding, the operational states will be described assuming system 100 also includes implementation of ACPI, and mapped to the ACPI states. For the embodiment, the operational states of system 100 include three major operational states, active state (ACPI S0 or simply, S0) 202, suspended state.(ACPI S3 or simply, S3) 204 and un-powered state (ACPI G3 or simply G3) 206. However, alternate embodiments may be practiced without mapping to ACPI states or implementation of ACPI. For further information on ACPI including ACPI states, see The ACPI Specification, Revision 2.0b.

Further, within active state (SO) 202, system 100 may be in “visual on” state 212, or “visual off” state 214. While system 100 is in “visual on” state 212, user perceptible indications of system activity may be selectively activated as appropriate, including but are not limited to display devices, light emitting diodes (LEDs), speakers, and so forth. On the other end, while system 100 is in “visual off” state 214, all visual and aural elements of system 100 are “off”, giving a user the impression that system 100 has been “turned off”. As illustrated, system 100 may transition between “visual on” state 212 and “visual off” state 214 based at least in part on power button (PB) events 222.

Having visual “on” and “off” states 212 and 214 within active state (SO) 202 is a non-essential aspect of the disclosed embodiments of the present invention. The feature is the subject matter of co-pending U.S. patent application, No. <to be inserted>, entitled <insert title>, and filed on mm/dd/yy. For further details, see the co-pending application.

Still referring to FIG. 2a, for the embodiment, within suspended state (S3) 204, system 100 may be in “suspended to memory” state 216 or “suspended to memory with a persistent copy of the system state saved” state 218. System 100 may enter into “suspended to memory” state 216 from either “visual on” state 202 or “visual off” state 204, due to e.g. “inactivity”, user instruction, or an “AC failure” condition, 224 and 226. System 100 is considered to be in the “AC failure” condition, whenever AC is not present at power supply 116.

Additionally, for the embodiment, as part of the entry into the “suspended to memory” state 216, a persistent copy of the then system state is saved, resulting in system 100 automatically transitions from “suspended to memory” state 216 to “suspended to memory with a persistent copy of the system state saved” state 218.

Automatic saving of a persistent copy of the then system state is also not an essential aspect of the disclosed embodiments of the present invention. The feature is the subject matter of co-pending U.S. patent application, No. <to be inserted>, entitled “Operational State Preservation in the Absence of AC Power”, and filed contemporaneously. For further details, see the co-pending application.

From “suspended to memory with a persistent copy of the system state saved” state 218, system 100 may enter un-powered state (G3) 206 if the integral DC power source is shut off or exhausted 230. Shutting the DC power source off to prevent it from being exhausted is also not an essential aspect of the disclosed embodiments of the present invention. The feature is the subject matter of co-pending U.S. patent application, No. <to be inserted>, entitled “Automatic Shut Off of DC Power Source in the Extended Absence of AC Power”, and filed contemporaneously. For further details, see the co-pending application.

From “suspended to memory with a persistent copy of system state saved” state 218, system 100 may transition back to either “visual on” state 212 or “visual off” state 214 in response to AC power re-presence, or a power button/device wake event 232 and 234 when AC is present (state 218 entered due to inactivity). As described earlier, power button or device wake events are advantageously suppressed or ignored, while system 100 is in suspended to memory state 128 during AC absence.

Further, system 100 returns to “visual off” state 214 if AC becomes present again while system 100 is in “un-powered” state (G3) 206.

Referring now to FIG. 2b, wherein one embodiment of power supply 116 is illustrated. As shown, for the embodiment, power supply 116 includes integral backup DC power source 132 and monitor 130 as described earlier. Additionally, power supply 116 includes multiple power outputs (also referred to as power rail) 244. The elements are coupled to each other as shown.

Accordingly, power outputs 244 may continue to supply power to elements of system 100, drawing on integral DC power source 132, in the absence of AC at power supply 116. Further, monitor 130 is able to output a signal denoting whether AC is present or absent at power supply 116 at any point in time.

In various embodiments, DC power source 132 may be a battery. Monitor 130 may be implemented employing a diode and RC coupled to a comparator to provide signal 136. Further, a logical “1” of signal 136 denotes AC present at power supply 116, whereas a logical “0” of signal 136 denotes AC absent at power supply 116.

In various embodiments, power outputs 244 may include normal and standby power outputs. Normal power outputs may include +12 v, +5 v, +3 v, and −12 v, whereas standby power output may include +5 v. Further, the normal power outputs may be turned off.

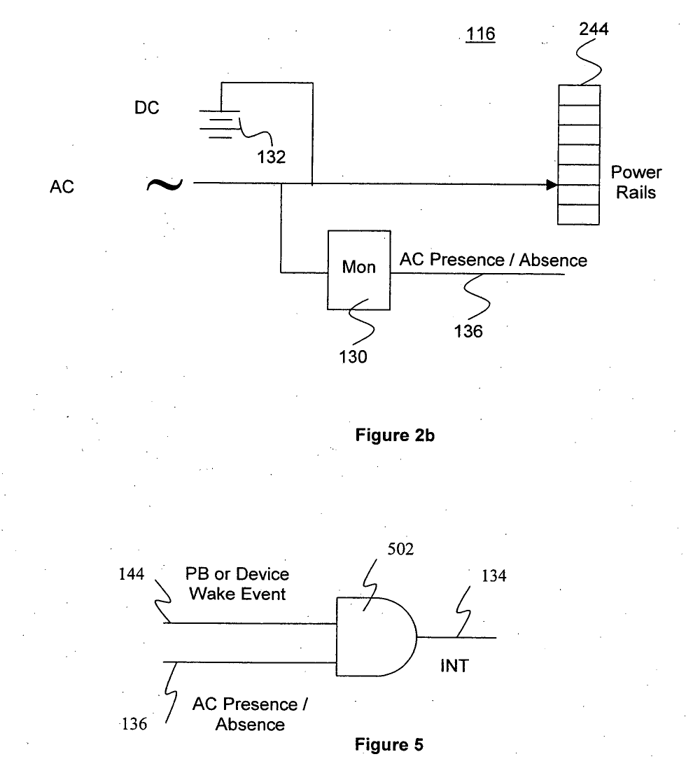

FIG. 3 illustrates one embodiment of the relevant operation flow of system 100 to suspend system 100 to memory, in responding to an AC failure condition, while operating in active state 202. As illustrated, while operating in active state 202, power supply 116 monitors for AC presence or absence, and outputs a signal to denote AC presence or absence accordingly, block 302. In alternate embodiments, the monitoring and signaling of AC presence or absence at power supply 116 may be performed by another element other than power supply 116. Regardless, the monitoring and signaling continues as long as AC is present at power supply 116.

However, when AC fails or absent from power supply 116, and monitor 130 outputs a signal so denoting, for the embodiment, MCH/ICH/BB 108 asserts an interrupt, block 304, notifying processor 102 to switch execution to a portion of OS 126 (interrupt handler) to place system 100 in a suspended state, block 306.

In various embodiments, the suspend process involves OS 126 writing to a special register of MCH/ICH/BB 108 to instruct MCH/ICH/BB 108 to shut off delivery of normal power to elements of system 100, leaving only delivery of standby power, e.g. to memory 106. In response, MCH/ICH/BB 108 shuts off delivery of normal power to elements of system 100, leaving only delivery of standby power, as instructed, block 308.

In various embodiments, system 100 is further equipped, and initialized to generate an interrupt and transfer control to BIOS 124 to allow BIOS 124 to intervene in the suspend process. For the embodiment, BIOS 124-intervenes to save a persistent copy of the then system state in persistent storage device 110, such as a hard disk drive, before allowing the suspend process to proceed to completion.

The ability for BIOS 124 to intervene and save a persistent copy of the then system state is also not an essential aspect of the disclosed embodiments of the present invention. It is the subject matter of the above-identified co-pending U.S. patent application, No. <to be inserted>.

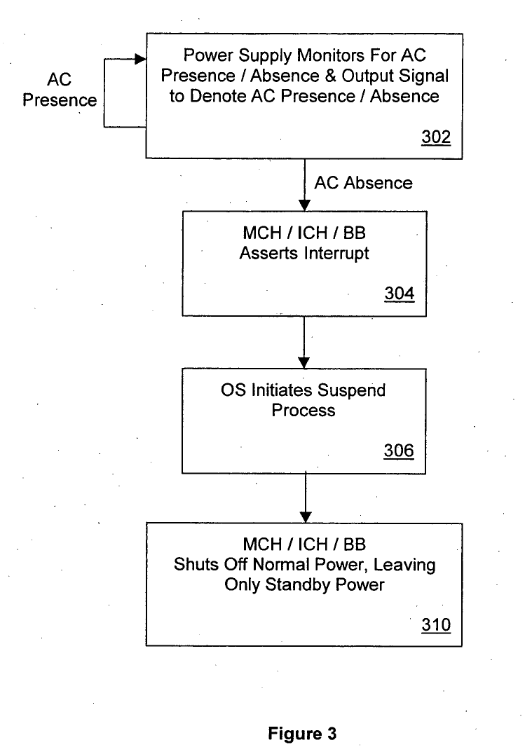

FIG. 4 illustrates one embodiment the relevant operation flow of system 100 to resume system 100 to an active state, in responding to an AC re-presence condition, while operating in a suspended state. Recall from earlier description, for the embodiment, the suspended state is “suspended to memory with a persistent copy of the system state saved” state 218. However, as described earlier, alternate embodiments may be practiced without the support for intervening in a suspend to memory process, and saving a persistent copy of the operational state of system 100.

As illustrated, for the embodiment, power supply 116 monitors for AC presence or absence and outputs a signal to denote AC presence or absence accordingly, while operating in state 218, block 402.

Again, as described earlier, in alternate embodiments, the monitoring and signaling-of AC presence or absence at power supply 116 may be performed by another element other than power supply 116. Regardless, the monitoring and signaling continues as long as AC is absent at power supply 116.

However, when AC is re-present at power supply 116, and monitor 130 outputs signal 136 so denoting. For the embodiment, MCH/ICH/BB 108 responds to signal 136 as a device wake event, re-enabling delivery of normal power outputs of power supply 116 to elements of system 100, and then transfers control to BIOS 124, block 404. As described earlier, in various embodiments, the device wake event is processed by the ICH portion of MCH/ICH/BB 108.

At block 406, BIOS 124 performs various initializations of hardware elements as appropriate, and transfers control to a resume vector previously set up by OS 126 (as part of the suspend to memory process).

At block 408, OS 126 completes the resume process, and system 100 continues operation, starting from the previously suspended system state in memory 106.

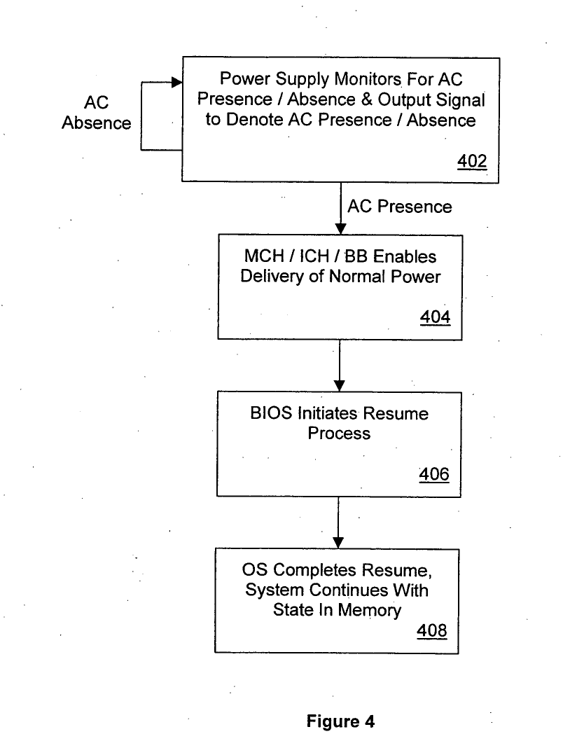

FIG. 5 illustrates an embodiment of a circuit suitable for suppressing power button and device wake events. As described earlier, in various embodiments, circuit 500 is disposed in MCH/ICH/BB 108, in particular in the ICH portion.

For the embodiment, circuit 500 comprises AND gate 502 performing a Boolean AND operation on a power button/device wake event signal 144 and AC presence/absence signal 136. Power button/device wake event signal 144 may be asserted by any one of a number of elements of system 100, including but are not limited a power button, a networking interface, and so forth. For the embodiment, a logical “1” of signal 136 denotes AC present at power supply 116, whereas a logical “0” of signal 136 denotes AC absent at power supply 116.

Thus, power button/device wake event signal 144 will be negated, during AC absence, since AC presence/absence signal 136 assumes logic “0”. Accordingly, the push button/device wake event may be suppressed or ignored when AC is absent at power supply 116.

For the embodiment, MCH/ICH/BB 108 is provided with and employs presence/absence signal 136 directly in the suppression/ignoring of a power button/device wake event signal 144. However, alternate embodiments may be practiced with power button/device wake event signal 144 being suppressed or ignored, employing a AC presence/absence state signal, that is generated by another element other than power supply 116 based on AC presence/absence signal 136 generated by power supply 116.

Alternate embodiments may also employ other logical elements to negate a power button or device wake event.

Thus, it can be seen from the above description, a method to conserve power, in particular, integral DC backup power, in the absence of AC has been described. As described earlier, the feature is particularly useful in enabling integral DC backup power to be provided to a computing device in a more cost effective manner.

While the present invention has been described in terms of the foregoing embodiments, those skilled in the art will recognize that the invention is not limited to the embodiments described. Other embodiments may be practiced with modification and alteration within the spirit and scope of the appended claims. Accordingly, the description is to be regarded as illustrative instead of restrictive.

1. In an apparatus, a method of operation comprising:
receiving a state signal signaling whether the apparatus is in an AC failure state;
receiving a power button event signal signaling an event associated with a power button of the apparatus; and
negating the power button event signal if the state signal signals the apparatus is in the AC failure state.

2. The method of claim 1, wherein the method further comprises
monitoring for absence of AC to a power supply of the apparatus; and
generating a power signal signaling AC failure on detection of absence of AC to the power supply.

3. The method of claim 2, wherein the monitoring and generating are performed by the power supply.

4. The method of claim 2, wherein the method further comprises a selected one of outputting the power signal as the state signal, and forming the state signal based at least in part on the power signal.

5. The method of claim 1, wherein the event associated with a power button of the apparatus comprises a power button being pressed event.

6. The method of claim 1, wherein the negating comprises combining the state signal and the power button event signal.

7. The method of claim 1, wherein the method further comprises
receiving a device wake event signal signaling a device wake event of the apparatus; and
negating the device wake event signal, if the state signal signals the apparatus is in the AC failure state.

8. In an apparatus, a method of operation comprising:
receiving a state signal signaling whether the apparatus is in an AC failure state;
receiving a device wake event signal signaling a device wake event of the apparatus; and
negating the device wake event signal if the state signal signals the apparatus is in the AC failure state.

9. The method of claim 8, wherein the method further comprises
monitoring for absence of AC to a power supply of the apparatus; and
generating a power signal signaling AC failure on detection of absence of AC to the power supply.

10. The method of claim 9, wherein the monitoring and generating are performed by the power supply.

11. The method of claim 9, wherein the method further comprises a selected one of outputting the power signal as the state signal, and forming the state signal based at least in part on the power signal.

12. The method of claim 8, wherein the negating comprises combining the state signal and the device wake event signal.

13. A system comprising:
an arrangement to generated a state signal signaling whether the system is in an AC failure state; and
a first circuit coupled to the arrangement to receive the state signal and a power button event signal indicating an event associated with a power button of the system, and to negate the power button event signal if the state signal signals the AC failure state.

14. The system of claim 13, wherein the system further comprises a monitor to monitor for presence or absence of AC to a power supply of the system, and to generate a power signal signaling accordingly.

15. The system of claim 14, wherein the system further comprises the power supply, and the monitor is an integral part of the power supply.

16. The system of claim 14, wherein the system further comprises a second circuit coupled to the power supply and the first circuit, to generate the state signal based at least in part on the power signal, and to provide the first circuit with the state signal.

17. The system of claim 13, wherein the first circuit comprises a signal combiner circuit element to combine the state signal and the power button event signal.

18. The system of claim 13, wherein
the system further comprises at least one hardware element equipped to generate a device wake event signal signaling a device wake event of the system; and
the first circuit is also equipped to negate the device wake event signal, if the state signal signals the apparatus is in the AC failure state.

19. The system of claim 13, wherein the system further comprise a networking interface.

20. A system comprising:
an arrangement to generate a state signal signaling whether the system is in an AC failure state; and
a first circuit coupled to the arrangement to receive the state signal and a device wake event signal signaling a device wake event of the system, and to negate the device wake event signal if the state signal signals the AC failure state.

21. The system of claim 20, wherein the system further comprises a monitor to monitor for presence or absence of AC to a power supply of the system, and to generate a power signal signaling accordingly.

22. The system of claim 21, wherein the system further comprises the power supply, and the monitor is an integral part of the power supply.

23. The system of claim 21, wherein the system further comprises a second circuit coupled to the power supply and the first circuit, to generate the state signal based at least in part on the power signal, and to provide the first circuit with the state signal.

24. The system of claim 20, wherein the first circuit comprises a signal combiner circuit element to combine the state signal and the device wake event signal.

25. The system of claim 20, wherein the system further comprise a networking interface.

26. An apparatus comprising:
a first input terminal to receive a first signal indicating presence or absence of AC to a power supply of a system;
a second input terminal to receive a second signal indicating a power button event of the system; and
a first combiner circuit element coupled to the first and second input terminals to combine the two signals to negate the second signal whenever the first signal signals absence of AC to the power supply.

27. The apparatus of claim 26, wherein the apparatus further comprises
a third input terminal to receive a third signal indicating a device wake event of the system; and
a second combiner circuit element coupled to the first and third input terminals to combine the two signals to negate the third signal whenever the first signal signals absence of AC to the power supply.

28. The apparatus of claim 27, wherein the first and third terminals are one of the same terminal, and the first and second signal combiner circuit elements are one of the same signal combiner circuit element.

29. An apparatus comprising:
a first input terminal to receive a first signal indicating presence or absence of AC to a power supply of a system;
a second input terminal to receive a second signal indicating a device wake event of the system; and
a first combiner circuit element coupled to the first and second input terminals to combine the two signals to negate the second signal whenever the first signal signals:absence of AC to the power supply.

30. The apparatus of claim 29, wherein the first and second input terminals are input pins.
